(19) United States
(12) Patent Application Publication
(10) Pub. No.: US 2018/0172880 A1
(43) Pub. Date: Jun. 21, 2018

(54) LIGHT GUIDE WITH ANTI REFLECTION FEATURE

(71) Applicant: 3M INNOVATIVE PROPERTIES COMPANY, St. Paul, MN (US)

(72) Inventor: Nicholas A. JOHNSON, Burnsville, MN (US)

(21) Appl. No.: 15/737,199

(22) PCT Filed: Jun. 14, 2016
(86) PCT No.: PCT/US2016/037411

§ 371 Date: Dec. 15, 2017

Related U.S. Application Data
(60) Provisional application No. 62/180,552, filed on Jun. 16, 2015.

(51) Int. Cl. G02B 1/11; F21V 8/00

(52) U.S. Cl. CPC G02B 1/11; G02B 6/0011

(57) ABSTRACT

Light guides with anti reflection features are disclosed. Anti reflection features that absorb light are disclosed. In some disclosed embodiments, a peak due to retrograde reflection off the non-launch edge of a light guide may be reduced to less than 5% or less than 1%.

### BACKGROUND

Lightguides are typically monolithic transparent bodies that are used to transport and spread light uniformly or otherwise over a desired areal extent. Light is typically injected into lightguides along a launch edge. Antireflection features are used to suppress reflection from an interface.

### SUMMARY

In one aspect, the present description relates to a lightguide. The lightguide includes a launch area having a launch edge extending along a first in-plane direction, a waveguiding area, and a non-launch area having a non-launch edge opposite the waveguiding area from the launch area, the non-launch edge extending along a second in-plane direction parallel to the first in-plane direction. The waveguiding area is substantially a constant thickness, and the non-launch area includes an antireflection feature to reduce visible retrograde reflection by the non-launch edge of visible light travelling within the lightguide from the launch edge to the non-launch edge.

In another aspect, the present description relates to a flat lightguide having a launch edge and a characteristic output distribution when visible light is coupled into the lightguide into the lightguide at the launch edge, wherein the output distribution characterized by visible intensity as a function of polar angle includes a primary peak, where the primary peak is bounded by its full width half maximum, where the primary peak has a full width half maximum of less than 30 degrees and where the primary peak includes more than 75% of the total output intensity of the lightguide. The output distribution also includes a secondary peak, where the secondary peak includes no more than 5% of the total output intensity of the lightguide.

### BRIEF DESCRIPTION OF THE DRAWINGS

FIG. 1 is an elevation view of a lightguide.

FIG. 2 is an elevation view of the lightguide of FIG. 1 demonstrating retrograde reflection.

FIG. 3 is an elevation view of the lightguide of FIG. 1 demonstrating optical effects of retrograde reflection.

FIG. 4 is an elevation view of a non-launch area of a lightguide having an antireflection feature.

FIG. 5 is an elevation view of a non-launch area of a lightguide having another antireflection feature.

FIG. 6 is an elevation view of a non-launch area of a lightguide having another antireflection feature.

FIG. 7 is an elevation view of a non-launch area of a lightguide having another antireflection feature.

FIG. 8 is a top perspective view of a non-launch area of a lightguide having another antireflection feature.

FIG. 9 is a graph of viewing angle versus intensity for a lightguide.

### DETAILED DESCRIPTION

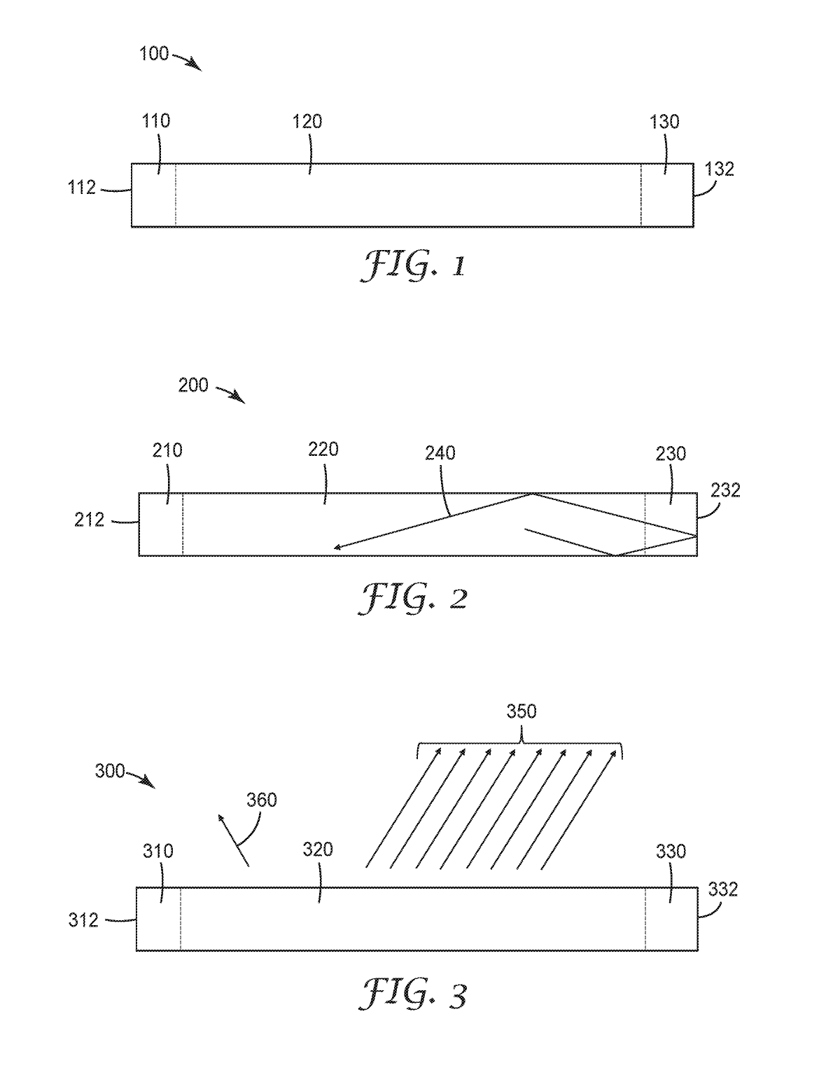

FIG. 1 is an elevation view of a lightguide. Lightguide 100 includes launch area 110 with launch edge 112, waveguiding area 120, and non-launch area 130 with non-launch edge 132.

Lightguide 100 may be any overall shape and size to suit the particular application of the lightguide. Typically, thinner lightguides are desirable for applications where thinness is a very important factor, such as in handheld devices. In some embodiments, lightguides may be thicker to provide dimensional stability in larger size applications, such as televisions. Certain lightguides may be wedge-shaped; however, for most modern applications, such a wedge lightguide, although providing excellent extraction, necessarily require that one end be much thicker than the other, rendering the overall shape and size difficult to accumulate. Lightguide may be formed from any suitable material and be formed through any suitable process. In some embodiments, lightguide 100 is formed from a transparent material. In some embodiments, lightguide 100 is formed from a polymer. In some embodiments, lightguide 100 is formed from acrylic glass (PMMA) or polycarbonate. Suitable lightguides may be formed in whole or in part by such processes such as injection molding, polishing, additive manufacturing, cast-and-cure, two-photon mastering, etching, laser ablating, reactive ion etching, or any other suitable process. In some embodiments, lightguide 100 is flexible.

Lightguide 100 includes a suitable pattern, number, and size of extractors. Light otherwise trapped in total internal reflection (guided mode light) within the lightguide due to being supercritical at the interface between the lightguide and air (or another lower index material or substance) interacts with an extractor and is redirected into subcritical light able to escape or be emitted from the lightguide. The selection and design of extractor shapes and sizes and extractor positioning and arrangement may provide a typically desirable uniform extraction over the areal extend of the lightguide. In some embodiments, the distribution of extractors for a given unit area occurs in a gradient: inversely proportional to the projected energy density at that unit area. In other words, because the energy density of light is greater nearer to the launch edge where light is injected into the lightguide, fewer extractors are desirable to maintain the uniformity of light throughout the entire active area.

Launch area 110 including launch edge 112 may be thicker than the rest of lightguide 100 and may include injection optics or other features to aid in the coupling of light sources or incident light into the lightguide. In some embodiments, one or more light sources may be partially or fully embedded in the launch area or, more particularly, in the launch edge. Launch area 110 may be outside of the active area of the lightguide, in that it is not designed to contribute to light used to illuminate a display.

Waveguiding area 120 should be substantially a constant thickness. Substantially a constant thickness may mean that the thickness of the waveguiding area does not vary by more than 5%, by more than 1% or by more than 0.1%. In some embodiments, substantially a constant thickness may mean that the thickness of the waveguiding area does not vary except for manufacturing variations. In some embodiments, substantially a constant thickness may mean that the thickness of the waveguiding area does not vary except for the presence of extractors or other optically active microfeatures.

Non-launch area 130 is opposite the waveguiding area from the launch area and includes non-launch edge 132. In some embodiments, and as described in more detail in conjunction with other figures, non-launch area 130 may include one or more antireflection features. Non-launch area 130 may be outside of the active area of the lightguide, in that it is not designed to contribute to light used to illuminate a display. Some or part of non-launch area 130 may be used to anchor or secure lightguide 100 in a backlight or display.

The precise boundaries of launch area 110, waveguiding area 120, and non-launch area 130 are somewhat fluid; however, in some embodiments, it may be helpful to assign a portion of lightguide 100 to each area. For example, in some embodiments, launch area 110 and non-launch area 130 may be the first and last, respectively, 20%, 15%, 10%, 5%, 2%, or 1% of the linear extent of the lightguide. The waveguiding area makes up the balance of the lightguide area by linear extent (i.e., the central 60%, 70%, 80%, 90%, 96%, or 98%). The launch area and the non-launch area may be different sizes from each other in some embodiments. In some embodiments, a specular reflector is disposed below lightguide 100 to enhance the reflection of light.

FIG. 2 is an elevation view of the lightguide of FIG. 1 demonstrating retrograde reflection. Lightguide 200 includes launch area 210 with launch edge 212, waveguiding area 220, and non-launch area 230 with non-launch edge 232. Exemplary ray 240 is shown to illustrate retrograde reflection off of non-launch edge 232. Exemplary ray 240 is being guided by total internal reflection off of the external surfaces of lightguide 200 when it is incident on non-launch edge 232. Depending on the angle of incidence and the relative index of refraction difference between lightguide 200 and the surrounding medium, exemplary ray 240 may be totally internally reflected at the non-launch edge interface or it may be partially reflected through Fresnel reflection due to the medium change. In any event, at least a portion of exemplary ray 240 is now retrograde to the normal direction of light travelling through the lightguide, from launch edge 212 to non-launch edge 212. Extractors designed for extracting non-retrograde light may extract retrograde light, but often not in an intended or designed direction.

FIG. 3 is an elevation view of the lightguide of FIG. 1 demonstrating optical effects of retrograde reflection. Lightguide 300 includes launch area 310 with launch edge 312, waveguiding area 320, and non-launch area 330 with non-launch edge 332. Highly collimated light 350 is emitted as well as retrograde light 360. FIG. 3 is similar to FIG. 2 except it shows the aggregate effect of light being extracted in the lightguide. In most cases, light may be extracted as highly collimated light 350. However, in some cases, retrograde light 360 is also present. For systems that rely on the highly collimated light (for example, a turning film system with high sensitivity to input angle), this retrograde light may create unwanted visual artifacts or provide visibility from locations not designed or intended to be viewable. Thus, in some applications, it may be desirable to eliminate or reduce the amount of retrograde light produced by a lightguide.

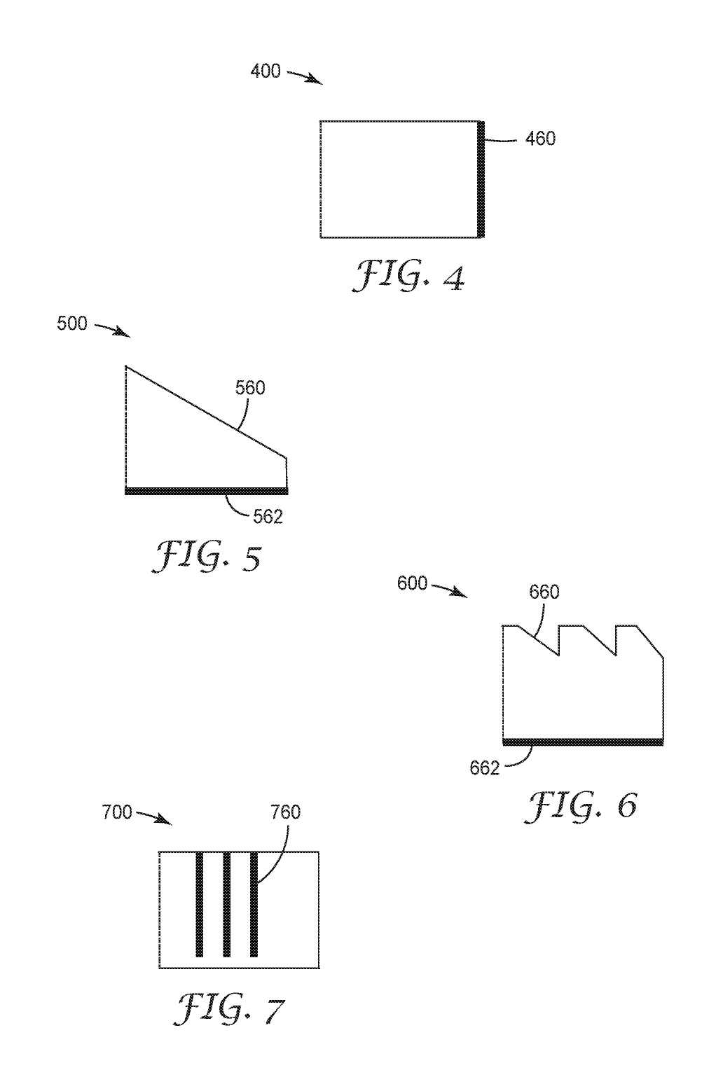

FIG. 4 is an elevation view of a non-launch area of a lightguide having an antireflection feature. Non-launch area 400 includes antireflection feature 460 disposed on or along the non-launch edge. Antireflection feature 460 may be an absorptive layer, such as absorptive paint (black or other suitable pigment), absorptive tape (rim or other suitable type), or a crossed pair of absorbing polarizers. In some embodiments, antireflection feature 460 may include a downconverter, such as quantum dots or a phosphor, suitable for absorbing visible light and reemitting it as invisible light, such as infrared light. In some embodiments, antireflection feature 460 may be an antireflective surface such as a moth's eye structure, a nanostructured antireflective surface, or any suitable antireflective coating.

FIG. 5 is an elevation view of a non-launch area of a lightguide having another antireflection feature. Non-launch area 500 includes non-launch edge 560 and antireflection feature 562 disposed opposite the non-launch edge. In FIG. 5, the positioning of the antireflection feature and the shape of the non-launch edge are such that at least some of the light incident on the non-launch edge is totally internally reflected by the non-launch edge and is coupled into the antireflection feature. Antireflection feature 562 may be any suitable antireflection feature, including absorptive layers, tapes, downconverters, or other structures.

FIG. 6 is an elevation view of a non-launch area of a lightguide having another antireflection feature. Non-launch area 600 includes microstructures 660 disposed on a top surface, opposite antireflection feature 662. Microstructures 660 are hollow or “innies” and are filled with air or another low index medium. Microstructures 660 optically behave similarly to non-launch edge 560 in FIG. 5 in that light is totally internally reflected off of the interface between the microstructures and air, such that the light is coupled into antireflection feature 662. Any suitable number of microstructures 660 may be used to provide the desired antireflective effect. Microstructures 660 may extend linearly for the width of the lightguide (in and out of the page) or they may be discrete features. Antireflection feature 662 may be any absorptive or other antireflection feature described herein.

FIG. 7 is an elevation view of a non-launch area of a lightguide having another antireflection feature. Non-launch area 700 includes antireflection features 760 that may be any suitable antireflection feature. In some embodiments, antireflection features 760 are microreplicated or cut channels in non-launch area 700 that are then filled with an absorptive material, such as carbon black. Multiple channels of antireflection features 760 may be used—having any suitable shape and size—to accomplish the desired absorption of light.

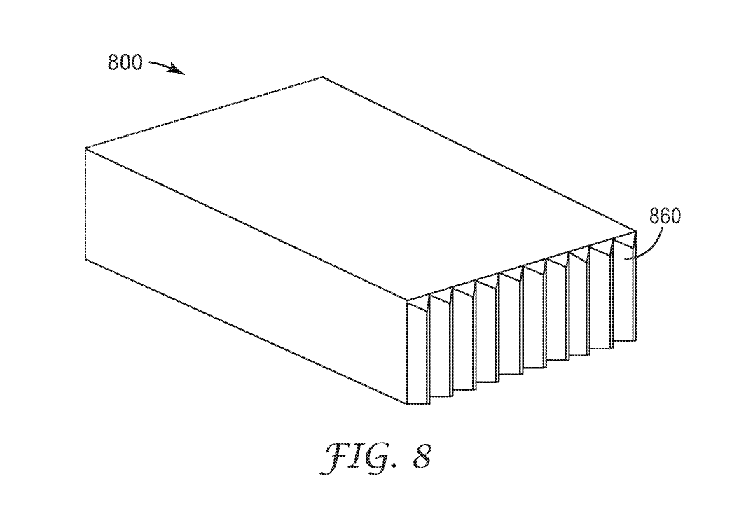

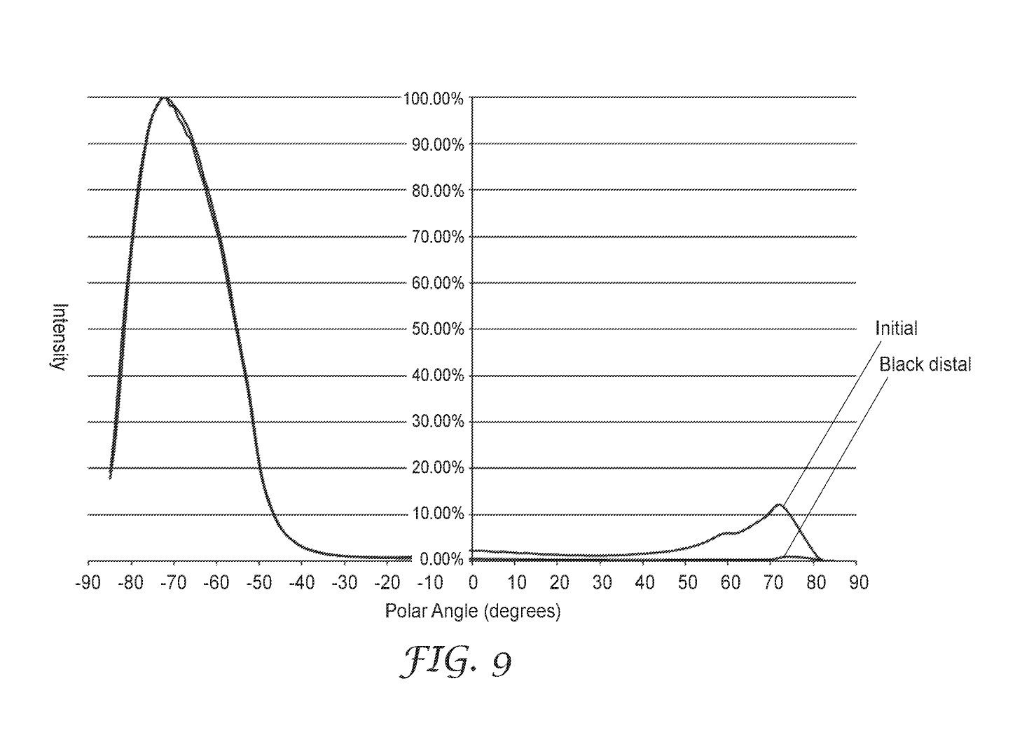

FIG. 8 is a top perspective view of a non-launch area of a lightguide having another antireflection feature. Non-launch area 800 includes a plurality of structures 860 extending along a thickness direction of the lightguide. The plurality of structures may be formed through any suitable method, such as a cast-and-cure microreplication process. In some embodiments, the plurality of structures may be injection molded along with the lightguide as a monolithic piece. In some embodiments, plurality of structures 860 are linear prisms. In some embodiments, plurality of structures 860 each has an apex angle, and each apex angle is less than 90 degrees. In some embodiment, each apex angle is less than 60 degrees. In some embodiments, each apex angle is less than 45 degrees. In some embodiments, each apex angle is less than 30 degrees. In some embodiments, plurality of structures 860 have flat facets. In some embodiments, plurality of structures 860 have curved facets in addition to or instead of flat facets. In some embodiments, plurality of structures 860 have piecewise curved or flat facets.

Other antireflection features not illustrated in detail are also possible and contemplated. For example, a lightguide may include wedge-shaped extractors that provide directionally selective extraction (i.e., light is efficiently extracted when incident on the extractor from a first direction but less efficiently extracted when incident on the extractor from a direction other than a first direction). Use of these extractors may be helpful to prevent the undesirable extraction of retrograde light.

Another example is to provide an abrupt change in the density of the extractors proximate the non-launch area. Abrupt may refer to a discontinuous or step change in the density of the extractors or a continuous but significantly quicker increase in the density proximate the non-launch area. This may prevent light from reaching the non-launch edge and becoming retrograde light. Any of the above illustrated or described antireflection features are possible alone or in combination.

### Examples

A commercially-available backlight from a DELL XPS series notebook computer (available from Dell Inc., Round Rock, Tex.) was removed. Other backlight components besides the lightguide and attached LEDs were separated and set aside. The back reflector was replaced with Enhanced Specular Reflector (ESR) (available from 3M Company, St. Paul, Minn.) and the lightguide/reflector combination was placed back into the backlight P-chassis. The LEDs were driven externally. The lightguide/reflector luminance versus view angle was measured by a WESTAR FPM-520 Display Optical Measurement System (available from Westar Display Technologies, St. Charles, Mo.) using a PR-705 SPECTRASCAN spectroradiometer (available from Photo Research, Inc., Chatsworth, Calif.). The luminance was converted to intensity and then was normalized as a percentage of the maximum value measured. This intensity is shown as a function of viewing angle as “initial” in FIG. 9.

The lightguide/reflector combination was removed. A black KRYLON SHORT CUTS hobby/craft paint pen (available from Sherwin-Williams Co., Cleveland, Ohio) was used to apply black paint to the non-launch edge of the lightguide. The lightguide/reflector combination was placed back in the P chassis and measured as before. This intensity is shown as a function of viewing angle as “Black distal” in FIG. 9.

Full-width half-maximum values (FWHM) for the primary peak and for the secondary peak (due to retrograde reflection) were calculated and the percentage of intensity within these peaks were calculated for both the as-received and painted lightguide data. As received, 77.2% of the total lightguide intensity was within the FWHM of the primary peak and 6.2% of the total lightguide intensity was within the FWHM of the secondary peak. With the non-launch edge painted black, 85.2% of the total lightguide intensity was within the FWHM of the primary peak and 0.4% of the total lightguide intensity was within the FWHM of the secondary peak. The primary peak had a FWHM of 27 degrees.

The following are exemplary embodiments according to the present disclosure.

Item 1. A lightguide, comprising:
a launch area having a launch edge extending along a first in-plane direction;
a waveguiding area; and
a non-launch area having a non-launch edge opposite the waveguiding area from the launch area, the non-launch edge extending along a second in-plane direction parallel to the first in-plane direction;
wherein the waveguiding area is substantially a constant thickness; and
wherein the non-launch area includes an antireflection feature to reduce visible retrograde reflection by the non-launch edge of visible light travelling within the lightguide from the launch edge to the non-launch edge.
   Item 2. The lightguide of item 1, wherein the antireflection feature includes absorptive paint disposed on the non-launch edge.
   Item 3. The lightguide of item 1, wherein the antireflection feature includes a plurality of structures extending along a thickness direction orthogonal to the second in-plane direction.
   Item 4. The lightguide of item 3, wherein the plurality of structures include linear prisms.
   Item 5. The lightguide of item 3, wherein each of the plurality of structures have an apex angle, and each apex angle is less than 45 degrees.
   Item 6. The lightguide of item 1, wherein the lightguide is flexible.
   Item 7. The lightguide of item 1, wherein the antireflection feature includes an absorptive tape disposed on the non-launch edge of the lightguide.
   Item 8. The lightguide of item 1, wherein the antireflection feature includes an absorptive tape disposed proximate to but not on the non-launch edge, and wherein the positioning of the absorptive tape and the shape of the non-launch edge are configured such that at least some light incident on the non-launch edge from the launch edge is coupled into the absorptive tape.
   Item 9. The lightguide of item 1, wherein the antireflection feature includes an abruptly dense extractor area proximate the non-launch edge.
   Item 10. The lightguide of item 1, wherein the antireflection feature includes a nanostructured antireflection surface.
   Item 11. The lightguide of item 1, wherein the antireflection feature includes a channel proximate to and extending parallel to the non-launch edge, wherein the channel includes carbon black.
   Item 12. The lightguide of item 1, wherein the antireflection feature includes an antireflective coating on the non-launch edge.
   Item 13. The lightguide of item 1, wherein the antireflection feature includes a moth's eye structure.
   Item 14. The lightguide of item 1, wherein the antireflection feature includes a downconverter.
   Item 15. A backlight, comprising the lightguide of item 1.
   Item 16. A display, comprising the backlight of item 15.
   Item 17. A flat lightguide having a launch edge and a characteristic output distribution when visible light is coupled into the lightguide at the launch edge, wherein the output distribution characterized by visible intensity as a function of polar angle comprises:
a primary peak, wherein the primary peak is bounded by its full width half maximum, wherein the primary peak has a full width half maximum of less than 30 degrees, and wherein the primary peak includes more than 75% of the total output intensity of the lightguide;
a secondary peak including no more than 5% of the total output intensity of the lightguide.
   Item 18. The lightguide of item 17, wherein the primary peak includes more than 80% of the total output intensity of the lightguide and the secondary peak includes no more than 1% of the total output intensity of the lightguide.
   Item 19. A backlight, comprising the lightguide of item 17.
   Item 20. A display, comprising the backlight of item 19.

Descriptions for elements in figures should be understood to apply equally to corresponding elements in other figures, unless indicated otherwise. The present invention should not be considered limited to the particular examples and embodiments described above, as such embodiments are described in detail in order to facilitate explanation of various aspects of the invention. Rather, the present invention should be understood to cover all aspects of the invention, including various modifications, equivalent processes, and alternative devices falling within the scope of the invention as defined by the appended claims and their equivalents.

1. A lightguide, comprising:
a launch area having a launch edge extending along a first in-plane direction;
a waveguiding area; and
a non-launch area having a non-launch edge opposite the waveguiding area from the launch area, the non-launch edge extending along a second in-plane direction parallel to the first in-plane direction;
wherein the waveguiding area is substantially a constant thickness;
wherein the non-launch area includes an antireflection feature to reduce visible retrograde reflection by the non-launch edge of visible light travelling within the lightguide from the launch edge to the non-launch edge; and
wherein the antireflection feature includes an absorptive tape disposed proximate to but not on the non-launch edge, and wherein the positioning of the absorptive tape and the shape of the non-launch edge are configured such that at least some light incident on the non-launch edge from the launch edge is coupled into the absorptive tape.

2. A backlight, comprising the lightguide of claim 1.

3. A display, comprising the backlight of claim 2.

4. A lightguide, comprising:
a launch area having a launch edge extending along a first in-plane direction;
a waveguiding area; and
a non-launch area having a non-launch edge opposite the waveguiding area from the launch area, the non-launch edge extending along a second in-plane direction parallel to the first in-plane direction;
wherein the waveguiding area is substantially a constant thickness;
wherein the non-launch area includes an antireflection feature to reduce visible retrograde reflection by the non-launch edge of visible light travelling within the lightguide from the launch edge to the non-launch edge; and
wherein the antireflection feature includes an abruptly dense extractor area proximate the non-launch edge.

5. A backlight, comprising the lightguide of claim 4.

6. A display, comprising the backlight of claim 5.

7. A lightguide, comprising:
a launch area having a launch edge extending along a first in-plane direction;
a waveguiding area; and
a non-launch area having a non-launch edge opposite the waveguiding area from the launch area, the non-launch edge extending along a second in-plane direction parallel to the first in-plane direction;
wherein the waveguiding area is substantially a constant thickness;
wherein the non-launch area includes an antireflection feature to reduce visible retrograde reflection by the non-launch edge of visible light travelling within the lightguide from the launch edge to the non-launch edge; and
wherein the antireflection feature includes a channel proximate to and extending parallel to the non-launch edge, wherein the channel includes carbon black.

8. A backlight, comprising the lightguide of claim 7.

9. A display, comprising the backlight of claim 8.

10-12. (canceled)

13. A flat lightguide having a launch edge and a characteristic output distribution when visible light is coupled into the lightguide at the launch edge, wherein the output distribution characterized by visible intensity as a function of polar angle comprises:
a primary peak, wherein the primary peak is bounded by its full width half maximum, wherein the primary peak has a full width half maximum of less than 30 degrees, and wherein the primary peak includes more than 75% of the total output intensity of the lightguide;
a secondary peak including no more than 5% of the total output intensity of the lightguide.

14. The lightguide of claim 13, wherein the primary peak includes more than 80% of the total output intensity of the lightguide and the secondary peak includes no more than 1% of the total output intensity of the lightguide.

15. A backlight, comprising the lightguide of claim 14.

16. A display, comprising the backlight of claim 15.
